(19) United States
(12) Patent Application Publication
(10) Pub. No.: US 2006/0092436 A1
(43) Pub. Date: May 4, 2006

(54) Methods and apparatus for inkjet printing of color filters for displays

(76) Inventors: John M. White, Hayward, CA (US); Fan Cheung Sze, San Jose, CA (US); Quanyuan Shang, Saratoga, CA (US); Shinichi Kurita, San Jose, CA (US); Hongbin Ji, Santa Clara, CA (US); Janusz Jozwiak, San Ramon, CA (US); Inchen Huang, Fremont, CA (US); Emanuel Beer, San Jose, CA (US)

Correspondence Address: DUGAN & DUGAN, PC, 55 SOUTH BROADWAY, TARRYTOWN, NY, 10591, US

(21) Appl. No.: 11/061,148

(22) Filed: Feb. 18, 2005

Related U.S. Application Data
(60) Provisional application No. 60/625,550, filed on Nov. 4, 2004.

(51) Int. Cl. G06K 15/02

(52) U.S. Cl. 358/1.2; 358/1.9; 358/1.8

(57) ABSTRACT

Methods and apparatus are provided wherein data representative of an image is received, the data being indicative of a plurality of theoretical ink jetting drop positions. The data may be converted into an image data file, the image data file being indicative of a plurality of actual physical ink jetting drop positions, each physical ink jetting drop position corresponding to a theoretical ink jetting drop position. A print system may be controlled based on the image data file, wherein the actual physical ink jetting drop positions may each be selected based upon being within a predefined percentage of a print resolution in a printing direction of a corresponding one of the theoretical ink jetting drop positions.

The present application claims priority from U.S. Provisional Patent Application Ser. No. 60/625,550, filed Nov. 4, 2004 and entitled “APPARATUS AND METHODS FOR FORMING COLOR FILTERS IN A FLAT PANEL DISPLAY BY USING INKJETTING” which is hereby incorporated by reference herein in its entirety.

### CROSS REFERENCE TO RELATED APPLICATIONS

The present application is related to U.S. patent application Ser. No. ______, Attorney Docket No. 9769, filed on even date herewith and entitled “METHODS AND APPARATUS FOR PRECISION CONTROL OF PRINT HEAD ASSEMBLIES” which is hereby incorporated by reference herein in its entirety.

### FIELD OF THE INVENTION

The present invention relates generally to systems for printing, and is more particularly concerned with image data for controlling operation of an inkjet printer.

### BACKGROUND OF THE INVENTION

The flat panel display industry has been attempting to employ inkjet printing to manufacture display devices, in particular, color filters. One problem with effective employment of inkjet printing is that it is difficult to inkjet ink or other material accurately and precisely on a substrate while having high throughput. Accordingly, methods and apparatus are needed to efficiently convert the electronic images into data that can be used to effectively and precisely drive a printer's control system.

### SUMMARY OF THE INVENTION

In a first aspect of the present invention, a method is provided wherein data representative of an image is received, the data being indicative of a plurality of theoretical drop positions. The data may be converted into an image data file, the image data file being indicative of a plurality of actual physical drop positions, each physical drop position corresponding to a theoretical drop position. A print system may be controlled based on the image data file, wherein the actual physical drop positions may each be selected based upon being within a predefined percentage of a print resolution in a printing direction of a corresponding one of the theoretical drop positions.

In a second aspect of the present invention, a controller is provided that includes a processor and a memory coupled to the processor. The memory may be adapted to store instructions executable on the processor to receive data representative of an image, the data being indicative of a plurality of theoretical drop positions, convert the data into an image data file, the image data file indicative of a plurality of actual physical drop positions, each physical drop position corresponding to a theoretical drop position, and control a print system based on the image data file. The actual physical drop positions may each be selected based upon being within a predefined percentage of a print resolution in a printing direction of a corresponding one of the theoretical drop positions.

In a third aspect of the present invention, an apparatus is provided that includes a communications port adapted to receive data representative of an image, the data being indicative of a plurality of theoretical drop positions, a controller coupled to the communications port and adapted to convert the data into an image data file, the image data file indicative of actual physical drop positions, each physical drop position corresponding to a theoretical drop position, and at least one driver coupled to the controller and adapted to control a print head based on the image data file. The actual physical drop positions may each be selected based upon being within a predefined percentage of a print resolution in a printing direction of a corresponding one of the plurality of theoretical drop positions.

In a fourth aspect of the present invention, a method is provided that includes storing substrate layout data for a substrate, determining print direction resolution data, determining coordinate data for a plurality of sub-pixels of the substrate, determining drop position data for each sub-pixel, and generating an image data file for the substrate.

In a fifth aspect of the present invention, a system for manufacturing display objects is provided that includes a controller, a driver coupled to the controller, a print head coupled to the driver, a stage controller coupled to the controller, a motor coupled to the stage controller, an encoder coupled to at least one of the motor and to the stage controller, and a host coupled to both the stage controller and the controller. The host may be adapted to transfer an image to the controller, the controller may be adapted to convert the image to an image data file suitable to be used to trigger the driver to cause the print head to deposit ink into sub-pixel wells on a substrate as the substrate is moved in a print direction by the motor under the direction of the stage controller in response to a command from the host.

Other features and aspects of the present invention will become more fully apparent from the following detailed description of exemplary embodiments, the appended claims and the accompanying drawings.

### BRIEF DESCRIPTION OF THE DRAWINGS

FIG. 1 is a schematic illustration of an inkjet print system according to some embodiments of the present invention.

FIG. 2A is a flowchart illustrating an example of a method of system operation according to some embodiments of the present invention.

FIG. 2B is a logic timing diagram that illustrates an example embodiment of the relationships between different signals of an inkjet print system according to the present invention.

FIG. 3 is a top view of a substrate including display objects for use with an inkjet print system according to some embodiments of the present invention.

FIG. 4 is a magnified view of a single display pixel of a display object on a substrate for use with an inkjet print system according to some embodiments of the present invention.

FIG. 5 is a flowchart illustrating an example of a method according to some embodiments of the present invention.

FIG. 6 is a flowchart illustrating details of an example of a sub-method of the method of FIG. 6 according to some embodiments of the present invention.

### DETAILED DESCRIPTION

Inkjet printers frequently make use of one or more inkjet print heads (or heads) mounted within a carriage that is moved back and forth across a substrate, such as paper or glass for a flat panel display. In some printers, the substrate is additionally or alternatively moved relative to the heads on a moving table top called a stage. As the substrate travels relative to the heads, a control system activates individual nozzles within the heads to deposit or eject ink (or other fluid) droplets onto the substrate to form images.

Activating a nozzle may include sending a fire pulse signal or pulse voltage to the individual nozzle to cause an ejection mechanism to dispense a quantity of ink. In some heads, the pulse voltage is used to trigger, for example, a piezoelectric element that pushes ink out of the nozzle. In other heads the pulse voltage causes a laser to irradiate a membrane that, in response to the laser light, pushes ink out of the nozzle. Other methods may be employed.

In a typical printer, images to be printed are represented as electronic images stored in a memory of the printer's control system. For example, pixels of an electronic image may be used to represent drop locations on the substrate.

The present invention provides apparatus and methods for defining an image of a filter to be “printed” on a substrate based on substrate layout data and fluid drop positions. In this manner, a print system of the present invention may efficiently and accurately deposit fluid on a substrate to form one or more filters. An exemplary algorithm for generating the image data based on substrate layout data and fluid drop positions is provided. The exemplary algorithm allows theoretical drop positions, as represented by a bitmap image of the filter, to be converted into actual physical drop positions (e.g., the actual locations of inkjet print head nozzles at the time fluid will be dispensed).

In some embodiments, a color filter for a display that may include a number of predefined wells formed on a substrate that will represent display pixels when the wells are filled with ink. In such embodiments, one ore more pixels of an electronic image may indicate the position where one or more drops of fluid are to be deposited to fill a display pixel well. The wells may be laid out on the substrate before printing using a process of coating, masking and etching.

System Overview

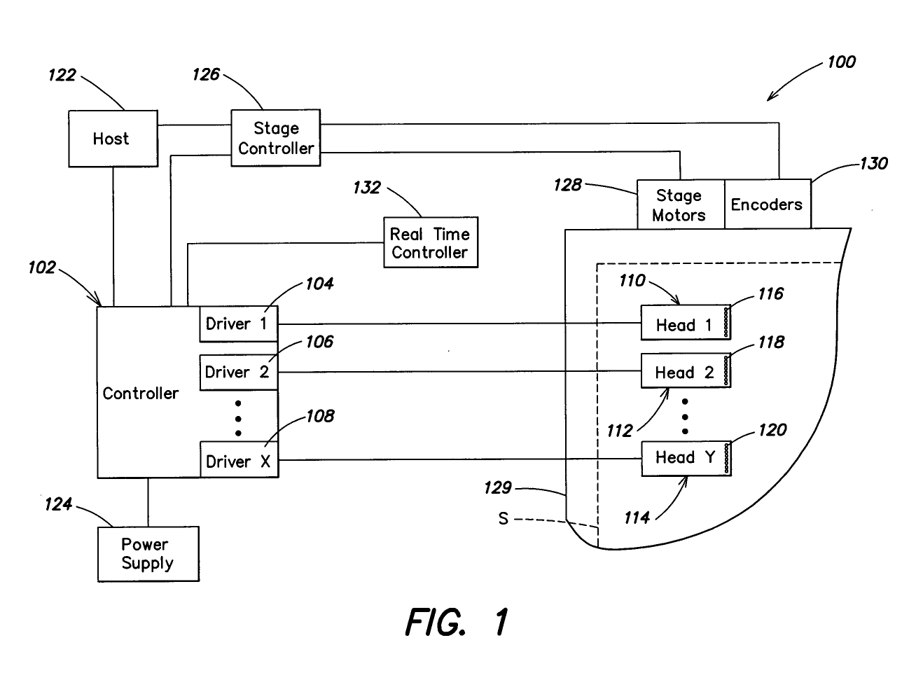

Turning to FIG. 1, a schematic illustration of an example embodiment of an inkjet print system 100 is provided. An inkjet print system 100 may include a controller 102 that includes a processor and/or sequencer (not pictured) and one or more memories (not pictured). The controller 102 may also include one or more drivers 104, 106, 108 that may each include circuitry to transmit data and control signals to one or more print heads 110, 112, 114. The print heads 110, 112, 114, may include one or more nozzles 116, 118, 120 for depositing fluid on a substrate S (shown in phantom). The controller 102 may additionally be coupled to a host computer 122 for receiving image and other data and to a power supply 124 for generating firing pulse signals.

In the embodiment shown, the host computer 122 is coupled to a stage controller 126 that may provide XY (e.g., horizontal and vertical) move commands to position the substrate S relative to the print heads 110, 112, 114. For example, the stage controller 126 may control one or more motors 128 to move a stage 129 that supports the substrate S. One or more encoders 130 may be coupled to the motors 128 and/or the stage 129 to provide motion feedback to the stage controller 126 which in turn may be coupled to the controller 102 to provide a signal that may be used to track the position of substrate S relative to the print heads 110, 112, 114. In some embodiments, a real time controller 132 may also be coupled to the controller 102 to provide a jet enable signal for enabling deposition of ink (or other fluid) as described further below. Although a connection is not pictured, the real time controller 132 may receive signals from the stage controller 126 and/or the encoders 130 in order to determine when the jet enable signal is to be asserted.

The controller 102 may be implemented using a field programmable gate array (FPGA) or other similar device. In some embodiments, discrete components may be used to implement the controller 102. The controller 102 may be adapted to control and/or monitor the operation of the inkjet print system 100 and one or more of various electrical and mechanical components and systems of the inkjet print system 100 which are described herein. In some embodiments, the controller 102 may be any suitable computer or computer system, or may include any number of computers or computer systems.

In some embodiments, the controller 102 may be or may include any components or devices which are typically used by, or used in connection with, a computer or computer system. Although not explicitly pictured in FIG. 1, the controller 102 may include a central processing unit(s), a read only memory (ROM) device and/or a random access memory (RAM) device. The controller 102 may also include an input device such as a keyboard and/or a mouse or other pointing device, an output device such as a printer or other device via which data and/or information may be obtained, and/or a display device such as a monitor for displaying information to a user or operator. The controller 102 may also include a transmitter and/or a receiver such as a LAN adapter or communications port for facilitating communication with other system components and/or in a network environment, one or more databases for storing any appropriate data and/or information, one or more programs or sets of instructions for executing methods of the present invention, and/or any other computer components or systems, including any peripheral devices.

According to some embodiments of the present invention, instructions of a program may be read into a memory of the controller 102 from another medium, such as from a ROM device to a RAM device or from a LAN adapter to a RAM device. Execution of sequences of the instructions in the program may cause the controller 102 to perform one or more of the process steps described herein. In alternative embodiments, hard-wired circuitry or integrated circuits may be used in place of, or in combination with, software instructions for implementation of the processes of the present invention. Thus, embodiments of the present invention are not limited to any specific combination of hardware, firmware, and/or software.

As indicated above, the controller 102 may generate, receive, and/or store databases including data related to images to be printed, substrate layout data, and/or substrate positioning and offset data. As will be understood by those skilled in the art, the schematic illustrations and accompanying descriptions of the sample data structures and relationships presented herein are exemplary arrangements for stored representations of information. Any number of other arrangements may be employed besides those suggested by the illustrations provided.

The drivers 104, 106, 108 may be embodied as a portion or portions of the controller's 102 logic as represented in FIG. 1. In alternative and/or additional embodiments, the drivers 104, 106, 108 may be embodied as separate circuits coupled to, but independent of, the controller 102. As pictured, each of the drivers 104, 106, 108 may be used to drive a corresponding print head 110, 112, 114. In some embodiments, one driver 104 may be used to driver all the print heads 110, 112, 114. The drivers 104, 106, 108 may be used to send data and clock signals to the corresponding print heads 110, 112, 114. In addition, the drivers 104, 106, 108 may be used to send firing pulse voltage signals to the corresponding print heads 110, 112, 114 to trigger individual nozzles of the print heads 110, 112, 114 to deposit specific quantities of ink or other fluid onto a substrate.

The drivers 104, 106, 108 may each be coupled directly to the power supply 118 so as to be able to generate a relatively high voltage firing pulse to trigger the nozzles to “jet” ink. In some embodiments, the power supply 118 may be a high voltage negative power supply adapted to generate signals having an amplitude of approximately 140 volts or more. Other voltages may be used. The drivers 104, 106, 108 may, under the control of the controller 102, send firing pulse voltage signals with specific amplitudes and durations so as to cause the nozzles of the print heads to dispense fluid drops of specific drop sizes as described, for example, in previously incorporated U.S. patent application Ser. No. 10/______, Attorney Docket No. 9769.

The print heads 110, 112, 114, may each include any number of nozzles 116, 118, 120. In some embodiments, each print head 110, 112, 114 may include one hundred twenty eight nozzles that may each be independently fired. An example of a commercially available print head suitable for used with the present invention is the model SX-128, 128-Channel Jetting Assembly manufactured by Spectra, Inc. of Lebanon, N.H. This particular jetting assembly includes two electrically independent piezoelectric slices, each with sixty-four addressable channels, which are combined to provide a total of 128 jets. The nozzles are arranged in a single line, at a 0.020″ distance between nozzles. The nozzles are designed to dispense drops from 10 to 12 picoliters but may be adapted to dispense from 10 to 30 picoliters. Other print heads may also be used.

Overall System Operation

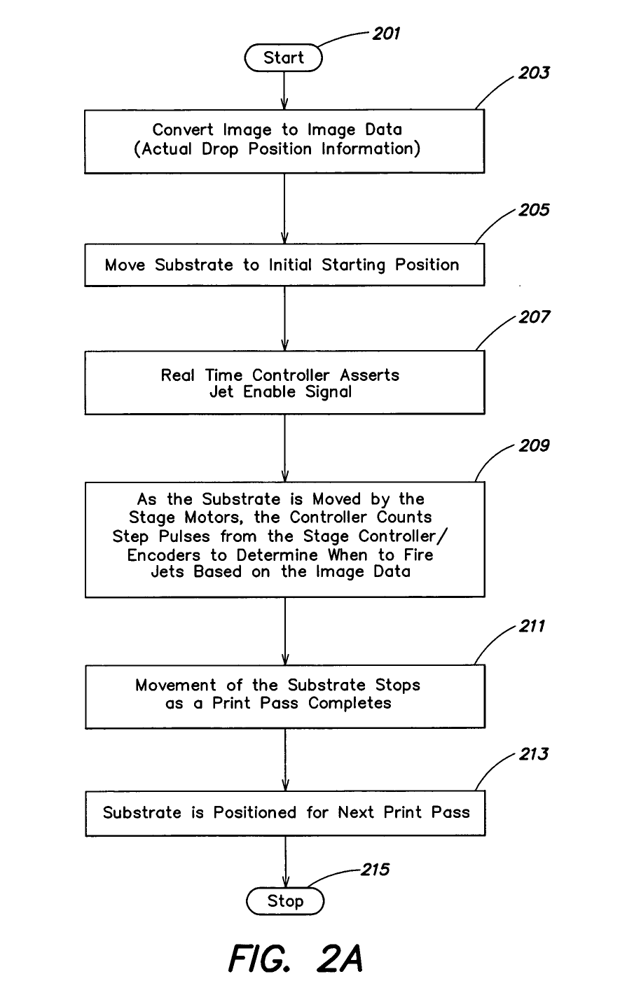

Referring to the flowchart of FIG. 2A, operation of the system begins at step 201. In operation, the inkjet print system 100 may initially convert a bitmap of an image to be printed to image data that represents the image in actual physical drop positions in step 203. This conversion may be executed on the host 122 and then the image data may be transferred to the controller 102. Alternatively, the conversion may be executed on the controller 102 after the bitmap image has been transfer from the host 122. In some embodiments, printing may commence before either all of the bitmap/image data has been received at the controller 102 and/or before all of the bitmap has been converted to image data.

As indicated above, it should be noted that although the example embodiment depicted in FIG. 1 may include particular data formats or databases stored in memory, other formats or database arrangements may be used which would still be in keeping with the spirit and scope of the present invention. For example, instead of a bitmap file, another graphics file format such as JIF or GIF may be employed. In other words, the present invention could be implemented using any number of different formats, database files, and/or data structures. Further, the individual data files may be stored on different devices (e.g. located on different storage devices in different physical locations, such as on the host 122). Likewise, a program may also be located remotely from the controller 102 and/or on the host 122. As indicated above, a program may include instructions for retrieving, manipulating, and storing data as may be useful in performing the methods of the invention as will be further described below.

Still referring to the flowchart of FIG. 2A, but also turning to the timing diagram 200 depicted in FIG. 2B, the host 122 may next issue a move command 202 to the stage controller 126 to cause the stage controller 126 to position the substrate S at a print pass starting position relative to the print heads 110, 112, 114 in step 205. Upon receiving an indication from the stage controller 126 that the stage is in position, in step 207 the real time controller 132 may assert the jet enable signal 204, thereby enabling the print heads 110, 112, 114.

In step 209, the stage controller 126 may then initiate a printing pass by asserting a start pulse 206 and step counter pulses 208 as the stage moves the substrate a predetermined amount of distance per step counter pulse in a printing pass direction. In some embodiments, the controller 102 may track the counter pulses 208 to determine a current position of the substrate. As the controller 102 receives the start pulse 206 and the step counter pulses 208, firing pulse voltage signals 210 may be sent by the controller 102 via the drivers 104, 106, 108 to individual nozzles that are arranged in a line (and may be approximately perpendicular to the printing pass direction, adjusted by a sable angle). The image data in the controller 102 specifies whether a particular nozzle is to receive a firing pulse voltage signal 210 that causes the nozzle to dispense fluid (i.e., “jet”) as it passes over a particular position (as indicated by the step counter pulses 208) in the printing pass direction. In step 211, when the end of a printing pass is reached, the stage controller 126 may assert a stop pulse 212 and, in response, the real time controller 132 may de-assert the jet enable signal 214. In step 213, a new move command 216 may be issued by the host 122 to position the substrate for a subsequent printing pass and the next printing pass may commence once the real time controller 132 asserts a jet enable signal. Other timing relationships and/or signals may be used. Once all printing pass have completed, the method terminates in step 215.

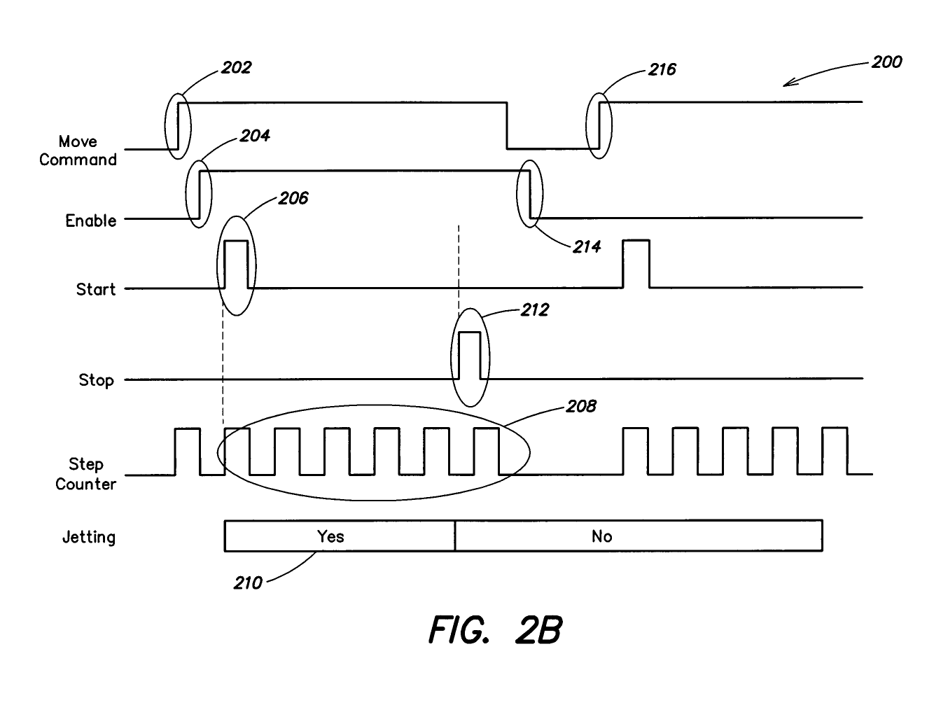

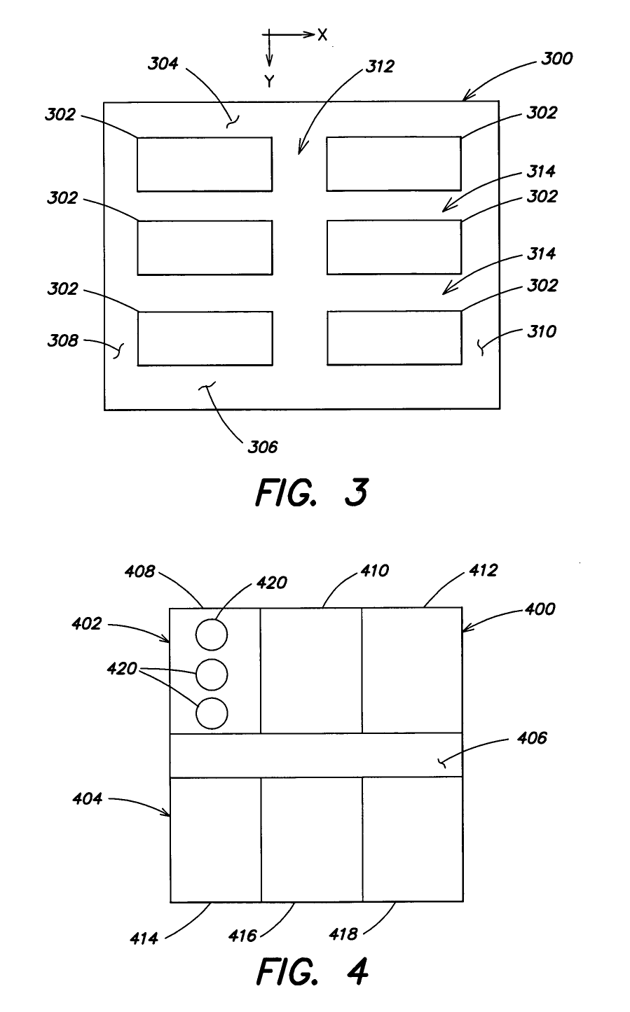

Turning to FIG. 3, a top view of an example substrate 300 is provided. The particular substrate 300 depicted in FIG. 3 is an example of a substrate 300 that may be suitable for use in manufacturing multiple display filters concurrently. With reference to FIG. 3, the substrate 300 includes six (6) individual display objects 302 that are shown as being contained on the substrate 300. However, any number of display objects 302 may be arranged on the substrate 300. As illustrated in FIG. 3, the substrate 300 may include a top margin 304, a bottom margin 306, a left side margin 308, and a right side margin 310. A gap 312 between display objects 302 in the X direction (e.g., perpendicular to the print direction moving horizontally across the substrate 300) is also shown. Gaps 314 between the display objects 302 in the Y direction (e.g., in the print direction moving vertically up or down the substrate 300) are also shown. Each display object 302 may include a number of display pixels (FIG. 4).

FIG. 4 is a top magnified view of an individual display pixel 400 of a display object 300 (FIG. 3), which, in an exemplary embodiment, includes two sub-pixels 402 and 404 separated by a capacitor line 406. In the particular example embodiment illustrated in FIG. 4, each sub-pixel 402, 404 includes three color filter regions 408, 410, 412; 414, 416, 418, respectively, each of the three being associated with a different color filter. A plurality of fluid drop positions 420 are shown in the left-most color region 408 of the top sub-pixel 402. Each of the fluid drop positions 320 are spaced a predetermined distance from the top edge of the top sub-pixel 402 and from each other so that the fluid drop locations 420 are equally spaced from each other and from the top and bottom edges of the sub-pixel 402. By placing the fluid drops at equal intervals, a more balanced and consistent color filter can be obtained. However, other drop position may be used. In cases in which the two sub-pixels 402, 404 are to have different volumes, the fluid drop volume can be adjusted differently between the two sub-pixels 402, 404 so that the filled thicknesses remain approximately the same despite a different in area.

As indicated above, a file including the image data used to control fluid drop positioning on a substrate can be generated by using one or more of substrate layout data, information regarding the number of fluid drops to be deposited in each sub-pixel's color filter region, the position and/or spacing of the fluid drops for each color filter region, any desired or required offset distances of a fluid drop position from a sub-pixel's edge, and/or information regarding the resolution of the image and/or the display object along the print direction (e.g., along the y-axis).

Substrate layout data can, for example, include data regarding the substrate, the type of substrate, the display objects(s) on the substrate, information regarding the display pixels and sub-pixels of the substrate, the length of the substrate in the X direction (e.g., perpendicular to the print direction) and/or in the Y direction (e.g., parallel to the print direction), the top margin of the substrate, the bottom margin of the substrate, the left side margin of the substrate, the right side margin of the substrate, the number and size(s) of any gap or gaps between display objects, the number of display objects in the X direction, and/or the number of display objects in the Y direction. Substrate layout data can also include any other information characteristic of the substrate, the display objects on the substrate, and/or any prescribed fluid drop positions for the sub-pixels of the display objects.

Substrate layout data can be used to determine the X and Y coordinate information for each of the sub-pixels and the sub-pixel color filter regions contained on the display objects.

Ink drop position can be specified by an offset distance from a top or bottom edge of a sub-pixel. Although FIG. 4 shows three (3) fluid drop positions 420 within a color filter region, any appropriate number of fluid drop positions can be specified. In an exemplary embodiment, as many as twenty (20) or more fluid drop positions can be specified and formed for a sub-pixel color filter region.

Based on information regarding the number and theoretical position of fluid drops along with the substrate layout data, the controller 102 (and/or host 122), in an exemplary embodiment, may determine the actual physical position for each fluid drop to be deposited in a respective sub-pixel color filter region. The controller 102 (and/or host 122) may be programmed to automatically determine the respective actual fluid drop positions so as to evenly distribute the fluid drops inside a sub-pixel's color filter region.

In some embodiments, the position of a fluid drop may be shifted from its desired location due to errors in motion of the stage 129 (FIG. 1) (e.g., due to motion accuracy or resolution) or offset errors between display objects. In extreme cases, a drop may land outside a target pixel region and become a defect. To avoid such errors, dynamic adjustment of inkjet head position during inkjetting may be employed. For example, a camera or other detector (e.g., such as a visualization device, an inspection device, and/or another similar device) may be employed to check inkjet head and/or nozzle position relative to a substrate pixel prior to inkjetting. Inkjet head and/or nozzle position information may be fed to the controller 102 (or other controller), and an offset may be determined to correct any positioning error, for example, for each display object.

In at least one embodiment, inkjet head position and/or nozzle firing/jetting time may be adjusted while printing (e.g., while the stage 129 is in motion) based on the determined offset. For example, assuming that the stage 129 travels along a y-axis direction (e.g., at a constant rate) during inkjetting, an error in the y-axis position of an inkjet head may be compensated for by jetting from a nozzle of the inkjet early, late or not at all. Likewise, an error in an x-axis direction position (e.g., perpendicular to the stage's direction of travel) may be compensated for by adjusting the x-axis position of the inkjet head prior to printing (e.g., by moving the inkjet head to the left or right relative to the direction of travel so that a nozzle is properly positioned over a pixel location). Such an “on-the-fly,” self compensation mechanism may greatly improve printing accuracy by compensating for dynamic errors in inkjet head position. In general, the in-line position, lateral position, height, pitch, yaw, etc., of a print head may be dynamically adjusted (e.g., while the stage remains in motion).

Data regarding the resolution in the print direction may also be used in generating image data. Further, a nozzle fire pulse signal, resulting in the dispensing of an ink (or other fluid) drop, may correspond to a predefined amount of information in the image data. Adjustments to the resolution in the print direction may also be used to correct offset errors between actual and theoretical drop positions.

Exemplary Method for Image Data Generation

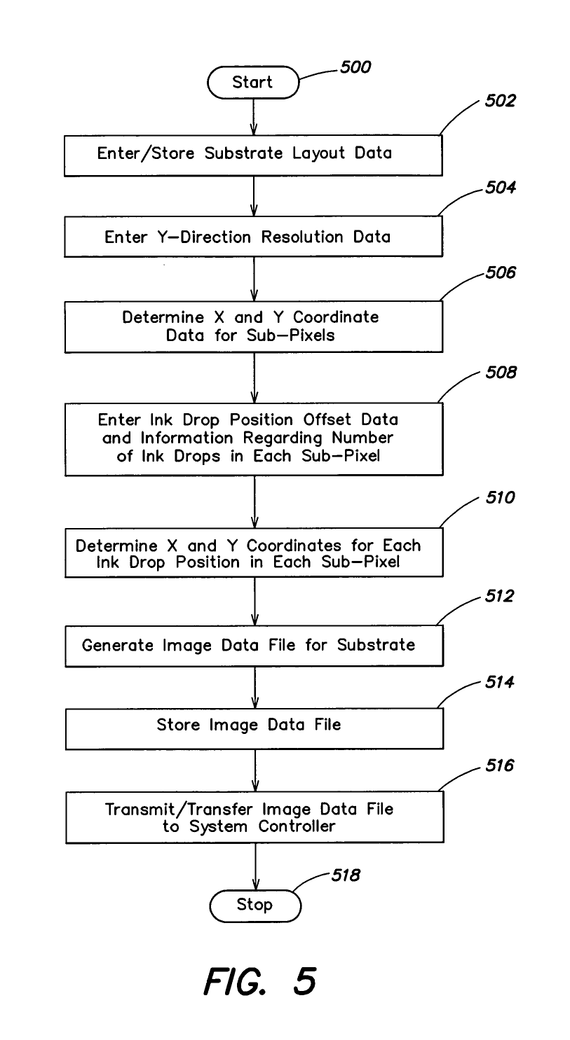

Image data may be generated by the controller 102 in any appropriate manner. FIG. 5 is a flowchart of an exemplary algorithm for generating an image data file. An image data file may correspond to a substrate having any number of display objects or a substrate having only a single display object.

With reference to FIG. 5, the operation of the controller 102 commences at Step 500. At step 502, substrate layout data for a substrate 300 may be entered into or loaded into the controller 102. In another exemplary embodiment, the substrate layout data may be retrieved from a memory device (not shown) located internal to the controller 102 or located in a memory device external from the controller 102. The substrate layout data can be input or loaded into the controller 102 from any appropriate storage medium such as, but not limited to a floppy disk, a compact disk (CD), a digital versatile disk (DVD), or any other suitable storage medium. In another exemplary embodiment, the substrate layout data can be transferred, downloaded, or uploaded, from another computer (e.g., a host 122) or database which can be adapted to store the substrate layout data.

The substrate layout data may include any of the data and/or information described above as well as data and/or information regarding the substrate, a display object or objects, display pixels, sub-pixels, the length in the x-direction of the substrate 300 and/or the display objects 302, the length in the y-direction of the substrate 300 and/or the display objects 302, the top margin 304, the bottom margin 306, the left side margin 308, the right side margin 310, any gap or gaps in the X-direction 312, any gap or gaps in the Y-direction 314, the number of display objects in the X-direction, the number of display objects in the Y-direction, and/or any other substrate layout data, and/or any other information, described herein and/or otherwise needed for generating an image data file for the substrate. The X and Y coordinates of each sub-pixel may be calculated from the substrate layout data.

At step 504, the resolution in the print direction (e.g., the Y direction), herein defined as R_{Y} or the resolution in distance between fluid drops during an inkjetting operation, may be input or loaded into the controller 102 or retrieved from a memory device of the controller 102 or from an external memory device, computer, or other source. Ry may be defined as the product of the speed of the stage 129 and the time interval between inkjetting operations. In an exemplary embodiment, a nozzle of a respective print head may be operated to jet approximately every 25 μsec (hereinafter “the jetting frequency”). If the stage 129 can move at a speed of approximately 500 mm/sec (hereinafter “the table speed”), a nozzle of a print head may fire approximately once every 12.5 μm. In this example, the resolution in the print direction (R_{Y}) is thus 12.5 μm. The resolution in the print direction (R_{Y}) may be any number which is a function of the nozzle jetting frequency and the table speed.

At step 506, the controller 102 may use the substrate layout data and/or the resolution in the print direction (R_{Y}) to determine the X and Y coordinates for each sub-pixel contained on each display object 302 on the substrate 300. At step 508, data or information regarding the fluid drop position offset and the number of fluid drops to be deposited in each sub-pixel color filter region may be entered into the controller 102, or retrieved from memory in the controller 102 or from an external memory device, computer or other source. The fluid drop positions may be specified or may be determined, for example, using fluid drop offset information and/or sub-pixel offset information.

In another exemplary embodiment, the fluid drop positions may be specified by the fluid drop offset inside the sub-pixel and/or by a number of ink drops to be deposited in the sub-pixel. For example, when the substrate 300 used is a 22″ WXGA substrate, a maximum number of ink drops in each sub-pixel may be limited to twenty drops. The maximum number, however, may be more or less than twenty drops depending upon the size of the sub-pixels, the size of the fluid drops in a given application, resolution (R_{Y}) and/or any other factors.

At step 510, the controller 102 can process the substrate layout data in connection with the data regarding the fluid drop offset and/or the number of fluid drops in a sub-pixel and determine the X and Y coordinates of each fluid drop to be placed in each sub-pixel of the display object 302. In an exemplary embodiment, the controller 102 may be programmed to automatically determine the position of each fluid drop as well as to evenly distribute the fluid drops inside a sub-pixel.

At step 512, the controller 102 may generate the image data file for the substrate 300. The controller 102 may used the image file data to control and monitor the operation of the inkjet print system 100, including controlling and/or monitoring the operation of any of the herein-described systems and components of the system 100. In an exemplary embodiment, the controller 102 may utilize the image data file in connection with information regarding any position or movement of the stage 129 in order to dispense ink drops in the sub-pixels of the display object(s) 302 which are contained on the substrate 300.

At step 514, the controller 102 may store the image data file. At step 516, the image data file may be transmitted to, transferred to, uploaded to, and/or downloaded to the host 122 for storage in a memory device of the host 122 or associated with the host 122. Thereafter, the operation of the controller 102 may cease at step 518 and await a next processing operation, whereupon the above-described process may be repeated for another or a different substrate.

Exemplary Method for Determining Fluid Drop Position

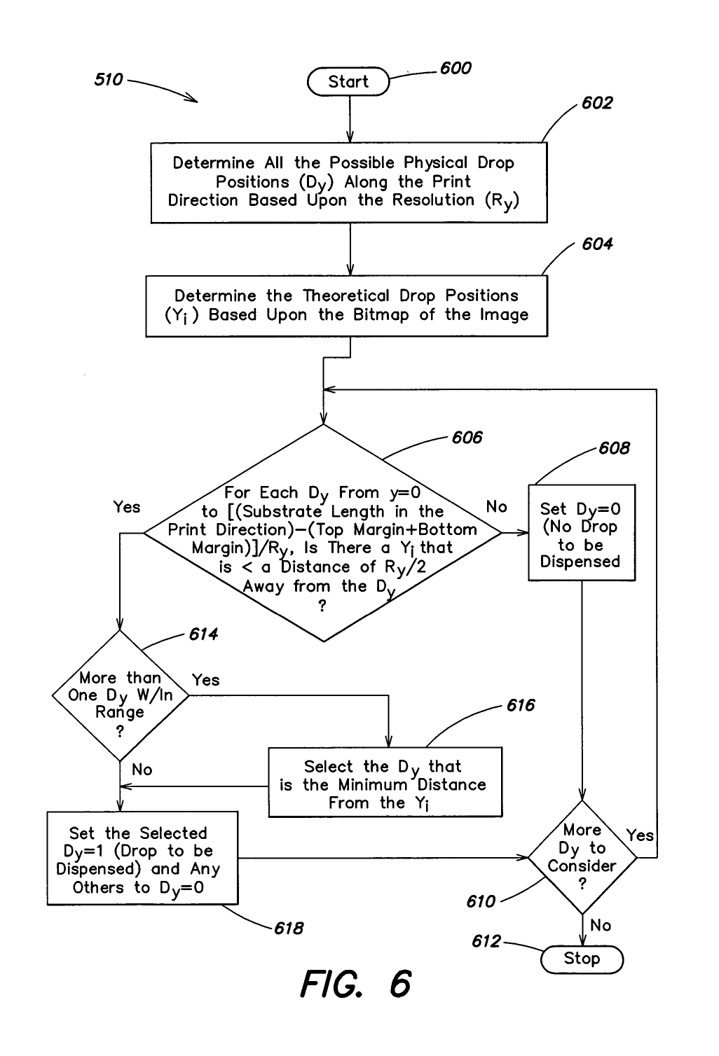

Turning to FIG. 6, a flowchart depicting an example method 510 for determining fluid drop position within a sub-pixel is provided. In other words, the steps of the method depicted in FIG. 6 provide details of how step 510 of FIG. 5 may be accomplished. The method 510 determines a representation of the theoretical drop positions in terms of actual physical drop positions.

The method 510 commences at step 600. In step 602, each of the possible physical drop positions (D_{y}) are determined based upon the resolution in the print direction (R_{y}) and substrate layout data. In step 604, the theoretical drop positions (Yᵢ) are determined based upon the bitmap of the image to be printed. In step 606, a determination is made for each of the possible physical drop positions whether there is a theoretical drop position (Yᵢ) within a distance of half of the resolution in the print direction (R_{y}/2). If not, flow proceeds to step 608 where the value of the particular possible physical drop position (D_{y}) last considered in step 606 is set to zero. Setting a D_{y} to zero indicates that no fluid will be dispensed at that particular location. Next, in step 610, if there are more possible physical drop positions to consider, flow returns to step 606. Otherwise, the method 510 completes at step 612.

If, in step 606, it is determined that one or more possible physical drop positions are within a distance of half of the resolution in the print direction (R_{y}/2) of a theoretical drop position (Yᵢ), then flow proceeds to step 614. In step 614, it is determined if more than one possible physical drop position is within the specified range of a given theoretical drop position (Yᵢ). If so, the possible physical drop position that is the minimum distance from the theoretical drop position (Yᵢ) is selected in step 616. The value of the selected physical drop position is next set to one in step 616 indicating that a drop of fluid will be dispensed at the selected physical drop position to represent the near-by theoretical drop position. Also in step 618, the value of any other unselected (in step 616) physical drop positions within the R_{y}/2 range are set to zero. Flow proceeds to step 610 and continues as described above.

Referring again to step 614, if there is only one possible physical drop position within the R_{y}/2 range, flow proceeds to step 618 and the value of the one possible physical drop position within the R_{y}/2 range is set to one. As above, flow continues to step 610 and proceeds as described above.

The above described method 510 effectively determines the X and Y coordinates for each drop position in a sub-pixel by assigning values to each of the possible actual physical drop positions that indicate whether or not a drop will be dispensed by a nozzle as the substrate S is moved under a print head in the print direction (e.g., the Y direction). In other words, the X coordinate is merely a function of the distance between nozzles on the print head and need not be explicitly determined. In some embodiments, the angle of the print head may be changed to reduce the effective distance between nozzles in the direction perpendicular to the print direction (e.g., the X direction). Such a technique may be used to achieve an effective increase of resolution in the direction perpendicular to the printing direction (e.g., the X direction).

The foregoing description discloses only particular embodiments of the invention; modifications of the above disclosed methods and apparatus which fall within the scope of the invention will be readily apparent to those of ordinary skill in the art.

Accordingly, while the present invention has been disclosed in connection with specific embodiments thereof, it should be understood that other embodiments may fall within the spirit and scope of the invention, as defined by the following claims.

The invention claim is:

1. A method comprising:
receiving data representative of an image, the data being indicative of a plurality of theoretical drop positions;
converting the data into an image data file, the image data file indicative of a plurality of actual physical drop positions, each physical drop position corresponding to a theoretical drop position; and
controlling a print system based on the image data file,
wherein the plurality of actual physical drop positions are each selected based upon being within a predefined percentage of a print resolution in a printing direction of a corresponding one of the plurality of theoretical drop positions.

2. The method of claim 1 wherein the image is representative of a display object sub-pixel well.

3. The method of claim 1 wherein converting the data into an image data file includes determining, for each possible physical drop position, if there is a theoretical drop position that is a distance that is less than half the print resolution in the printing direction from a possible physical drop position.

4. The method of claim 1 further including assigning a value representative of a drop to be dispensed to a possible physical drop position within a predefined range of a theoretical drop position.

5. The method of claim 4 wherein the predefined range is less than half a distance that is the print resolution in the printing direction.

6. The method of claim 4 further including assigning a value representative of a drop not to be dispensed to a possible physical drop position outside a predefined range of any theoretical drop position.

7. A controller comprising:
a processor; and
a memory coupled to the processor and adapted to store instructions executable on the processor to:
receive data representative of an image, the data being indicative of a plurality of theoretical drop positions,
convert the data into an image data file, the image data file indicative of a plurality of actual physical drop positions, each physical drop position corresponding to a theoretical drop position, and
control a print system based on the image data file,
wherein the plurality of actual physical drop positions are each selected based upon being within a predefined percentage of a print resolution in a printing direction of a corresponding one of the plurality of theoretical drop positions.

8. The controller of claim 7 wherein the image is representative of a display object sub-pixel well.

9. The controller of claim 7 wherein the instruction to convert the data into an image data file includes an instruction to determine, for each possible physical drop position, if there is a theoretical drop position that is a distance that is less than half the print resolution in the printing direction from a possible physical drop position.

10. The controller of claim 7 wherein the instructions further include assignment of a value representative of a drop to be dispensed to a possible physical drop position within a predefined range of a theoretical drop position.

11. The controller of claim 10 wherein the predefined range is less than half a distance that is the print resolution in the printing direction.

12. The controller of claim 10 wherein the instructions further include assignment of a value representative of a drop not to be dispensed to a possible physical drop position outside a predefined range of any theoretical drop position.

13. An apparatus comprising:
a communications port adapted to receive data representative of an image, the data being indicative of a plurality of theoretical drop positions;
a controller coupled to the communications port and adapted to convert the data into an image data file, the image data file indicative of a plurality of actual physical drop positions, each physical drop position corresponding to a theoretical drop position; and
at least one driver coupled to the controller and adapted to control a print head based on the image data file,
wherein the plurality of actual physical drop positions are each selected based upon being within a predefined percentage of a print resolution in a printing direction of a corresponding one of the plurality of theoretical drop positions.

14. A method comprising:
storing substrate layout data for a substrate;
determining print direction resolution data;
determining coordinate data for a plurality of sub-pixels of the substrate;
determining drop position data for each sub-pixel; and
generating an image data file for the substrate.

15. The method of claim 14 further comprising:
entering drop position offset data.

16. The method of claim 14 further comprising:
entering information indicative of a number of drops to be dispensed within each sub-pixel.

17. The method of claim 14 further including transferring the image data file for the substrate to a controller adapted to dispense ink into sub-pixels on the substrate based on the image data file.

18. A system for manufacturing display objects comprising:
a controller;
at least one driver coupled to the controller;
at least one print head coupled to the at least one driver;
a stage controller coupled to the controller;
at least one motor coupled to the stage controller;
at least one encoder coupled to at least one or more of the at least one motor and the stage controller; and
a host coupled to the stage controller and the controller,
wherein the host is adapted to transfer an image to the controller, the controller is adapted to convert the image to an image data file suitable to be used to trigger the driver to cause the print head to deposit ink into sub-pixel wells on a substrate as the substrate is moved in a print direction by the motor under the direction of the stage controller in response to a command from the host.

19. The method of claim 18 further comprising a real time controller coupled to the controller and operative to enable operation of the system based upon feedback from the controller.
